(19) United States
(12) Patent Application Publication
(10) Pub. No.: US 2008/0291294 A1
(43) Pub. Date: Nov. 27, 2008

(54) Mobile Terminal Capable of Modifying a Flash Image and Method of Modifying a Flash Image Therewith

(75) Inventor: Young Muk Cha, Seoul (KR)

Correspondence Address: ROTHWELL, FIGG, ERNST & MANBECK, P.C., 1425 K STREET, N.W., SUITE 800, WASHINGTON, DC, 20005, US

(73) Assignee: MOBIDERS, INC., Seoul (KR)

(21) Appl. No.: 12/096,865

(22) PCT Filed: Sep. 13, 2006
(86) PCT No.: PCT/KR2006/003642

§ 371 Date: Jun. 10, 2008

(30) Foreign Application Priority Data
Mar. 27, 2006 (KR) 10-2006-0027578

(51) Int. Cl. H04N 5/76

(52) U.S. Cl. 348/231.2

(57) ABSTRACT

A mobile terminal capable of modifying a flash image is provided. The mobile terminal comprises a program configured to execute the steps of displaying the flash image stored in a first memory of the mobile terminal on the display unit; activating the object of the displayed flash image in response to the selection of the location change menu; selecting the activated object; capsulating the elements forming the selected object; generating a relative coordinate of a reference point for the generated capsule; obtaining a relative coordinate of the elements forming the selected object for the reference point of the capsule; and storing the relative coordinate of the capsule and the relative coordinate of the elements forming for the capsule into the third memory. According to the above steps, modifying the flash image is performed. Accordingly, a SWF flash image may be directly modified to move a flash object to a desired position without the process of decompiling the flash image into a FLA format. Therefore, it is not require for a de-compiler for converting a FLA flash file into a SWF format so that editing of a SWF file becomes feasible.

### TECHNICAL FIELD

The present invention relates to a mobile terminal capable of modifying a flash image and method of modifying a flash image thereof.

### BACKGROUND ART

SWF is a vector graphic file format produced by the Flash software from Adobe. A SWF file with .swf extension is displayed on a PC screen through a user interface to the internet or other network such as a web browser, or a plug-in. A flash file with .fla extension is in a format that is for use in performing specific tasks such as modifying or deletion on the flash file. An image that is viewed by a user is in a SWF format. The SWF file(completed file) is processed in a FLA file(processing file) and published from the FLA file.

FIG. 1 illustrates a bitmap image 100; FIG. 2 illustrates a process of synthesizing of the image 100 shown in FIG. 1 with a flash image 120 and storing the synthesized image as a new flash image 200; FIG. 3 illustrates a process of synthesizing the flash image 200 stored in FIG. 2 with a new flash image as an object 130; FIG. 4 illustrates a process of synthesizing two flash images as objects 130, 140 with the flash image 200; and FIG. 5 is a virtual cross sectional side view of a compound flash image 300 shown in FIG. 4.

As shown in FIG. 2 and FIG. 5, the flash image 120 is comprised of background 121 and an object layer 123. The object 123 shown in FIG. 2 is produced with a frame format. In case of synthesizing the flash image 120 with the bitmap image 100 like the JPEG format to generate a new flash image 200, the image 100 synthesized in the flash image 120 is interposed between background 121 and the object layer 123, thereby, generating a new layer and a new flash image 200.

As shown in FIG. 3 and FIG. 4, in case of synthesizing the flash image 200 with the flash image 130, 140 as an object, the flash image 130, 140 forms a new layer as shown in FIG. 5 and stored as a new flash image 300.

FIG. 6 is an enlarged view of the object of the flash image shown in FIG. 3. As shown in FIG. 6, the object 130 which is a flash image that forms a flash image 300 is comprised of one or more elements 131.

FIG. 7 is a drawing illustrating an example of changing the position, the size, or the color of a flash image 500 according to the related art. In order to edit the position, the size, or the color of the stored flash SWF file, the flash image of SWF format needs to be decompiled as a FLA format, as is illustrated with a reference number 135 in FIG. 7. Then, the size, position, or color of an element that forms each layer of the decompiled FLA file is modified. In this manner, the position or the color of the flash image is modified. FIG. 7 shows a screen capture of a program, ‘Macromedia Flash Professional 8,’ that is used to modify a FLA format file that is decompiled from a flash image of SWF format, to create a FLA file, or to compile a FLA format file that has been created or edited to create a SWF format file. In FIG. 7, the reference number 135 which is not described represents a file name of a transformed FLA format, while a reference number 136 represents a menu that inserts a new object or a new timeline to a FLA format file in editing. A reference number 137 represents a menu that modifies a transformed FLA file, a reference number 138 represents a menu that opens or saves files, a reference number 134 represents a layer of element forming the flash image, a reference number 500 represents a flash file of a transformed FLA format, and reference numbers 510 through 560 represent elements forming the object of the flash file.

Generally, in order to create a SWF file that is viewed to a user, a specialized application program is used to create a FLA file and compile the created FLA file into a SWF file. In case of modifying a SWF file that has been already created, the SWF file needs to be decompiled as FLA file format, and the decompiled FLA file is modified and edited to be compiled into a SWF format. That is, a program shown in FIG. 7 is used to create a FLA flash file, or to modify a decompiled FLA file, and create a SWF file by compiling the modified FLA file into a SWF format.

Therefore, in order to create or modify a flash image, a specialized application program as described above is required for modifying a decompiled FLA file and compiling it again, thus, such creation or modification can only be carried out in an equipment such as PC. Therefore, in a mobile terminal which is recently increasing in use, there is a problem in that any alteration cannot be made on an existing flash image stored in an initial stage, as the flash image which is already stored can not be edited.

### DISCLOSURE

### Technical Problem

Accordingly, an object of the present invention is to solve at least the problems and disadvantages of the related art.

An object of the present invention is to provide a mobile terminal, which is capable of directly modifying a flash image of SWF format in a mobile terminal and storing a modified flash image simply without the program for converting the format of the flash image, and a method of modifying an image thereof.

### Technical Solution

According to an aspect of the invention, there is provided a mobile terminal capable of modifying a flash image, which comprises a memory including a first memory that stores an image; a second memory that stores an editing program; and a third memory that is a temporal memory temporarily storing a data; a key input unit including a control key that receives a control command; and a numeric/character key that receives a numeric or a character; and a display unit that displays a numeric, a character or an image inputted under the control of a controller, wherein an editing program stored in the second memory is configured to execute the steps of activating an object provided for a flash image displayed on the display unit; selecting the activated object by the control key and capsulating the selected object; modifying the capsulated object; and storing the modified flash image into the first memory.

The capsulating of the selected object includes generating a capsule that encompasses elements forming the selected object; generating a relative coordinate for a reference point of the generated capsule to be stored into the third memory; and obtaining a relative position(coordinate) of the elements of the object for the generated capsule to be stored into the third memory.

The modifying of the capsulated object includes modifying the relative coordinate of the capsule by pressing an arrow key; modifying the relative coordinate of the elements for the capsule to be stored into the third memory; and moving the selected object to a new position by replacing the relative coordinate of the capsule and the relative coordinate of the elements which are modified to be stored with the relative coordinate of the elements provided for the flash image.

A method of modifying a flash image in accordance with the mobile terminal of the present invention capable of modifying the flash image, which comprises displaying the flash image stored in a first memory of the mobile terminal on a display unit; activating an object forming the displayed flash image in response to the selection of a location change menu; selecting the activated object; capsulating the selected object; modifying the capsulated object; and storing the modified flash image.

The capsulating of the selected object includes generating a capsule that encompasses elements forming the object in case of selecting the object; generating a relative coordinate for a reference point of the generated capsule; obtaining a relative coordinate of the elements of the selected object for the reference point of the capsule; and storing the relative coordinate of the capsule and the relative coordinate of the element forming the object for the capsule into the third memory.

The modifying the capsulated object includes modifying the relative coordinate of the capsule and the relative coordinate of the elements for the capsule by pressing the arrow key to be stored into the third memory; and moving the selected object to a new position by replacing the relative coordinate of the capsule and the relative coordinate of the elements which are modified to be stored with the relative coordinate of the elements provided for the flash image.

In the mobile terminal capable of modifying a flash image and a method of modifying a flash image thereof according to example embodiments of the present invention, a SWF flash image may be directly modified to move a flash object to a desired position without the process of decompiling the flash image into a FLA format. Therefore, it is not require for a de-compiler for converting a FLA flash file into a SWF format so that editing of a SWF file becomes feasible.

### BRIEF DESCRIPTION OF THE DRAWINGS

The above and other advantages of the present invention will become more apparent by describing in detail exemplary embodiments thereof with reference to the accompanying drawings, in which:

FIG. 1 illustrates an image file of bitmap format that is photographed by or stored in a mobile terminal;

FIG. 2 illustrates a process of synthesizing an image shown in FIG. 1 with a frame object of a flash image;

FIG. 3 illustrates a process of selecting another flash image to synthesize with the synthesized flash as shown in FIG. 2;

FIG. 4 illustrates a flash image synthesized with two or more flash objects through the process of FIG. 3;

FIG. 5 is a cross sectional side view of the synthesized flash image shown in FIG. 4;

FIG. 6 is an enlarged view of a flash image shown in FIG. 3;

FIG. 7 is a drawing illustrating an example of converting a position, or a size of the flash image in FIG. 6;

FIG. 8 is a block diagram illustrating a mobile terminal capable of an image modification according to the present invention;

FIG. 9 is a flowchart illustrating the process of an image modification by a mobile terminal according to the present invention;

FIG. 10 illustrates an object that is activated and selected in the image modification of a mobile terminal of the present invention; and

FIG. 11 is a plan view illustrating an example of control keys of a mobile terminal according to the present invention.

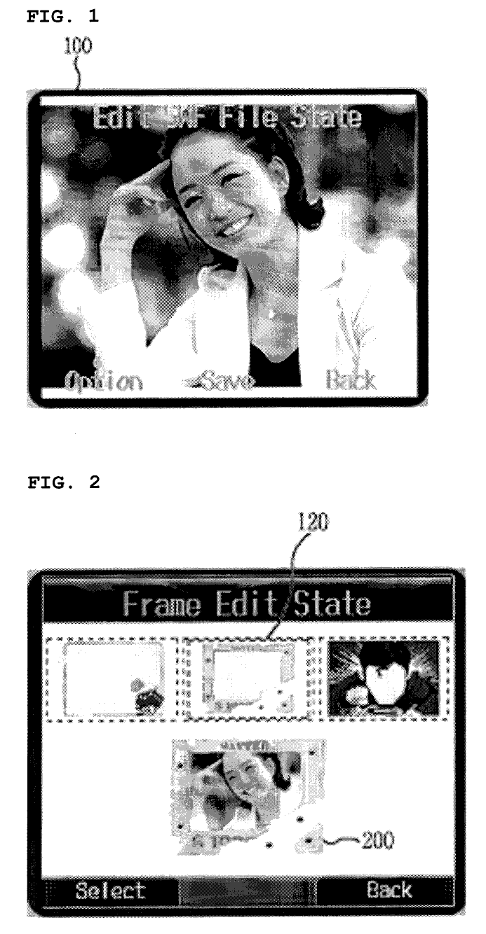

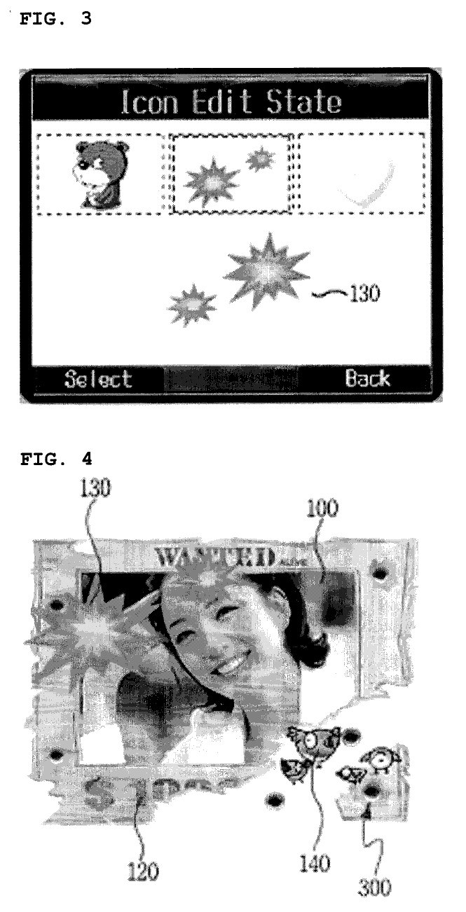

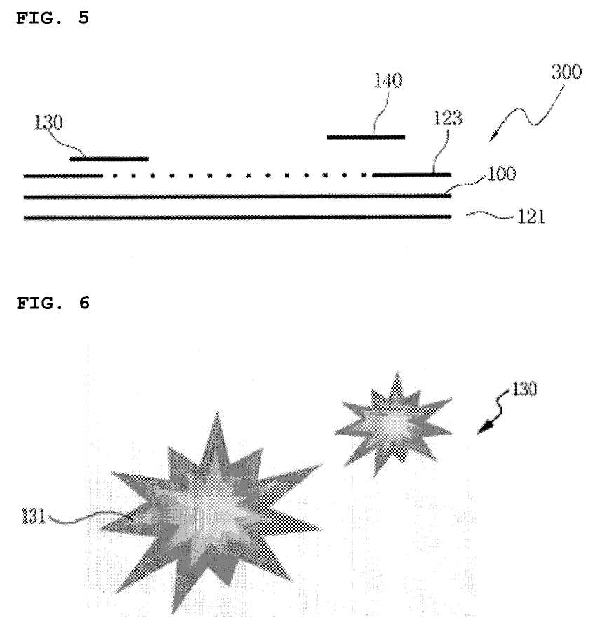

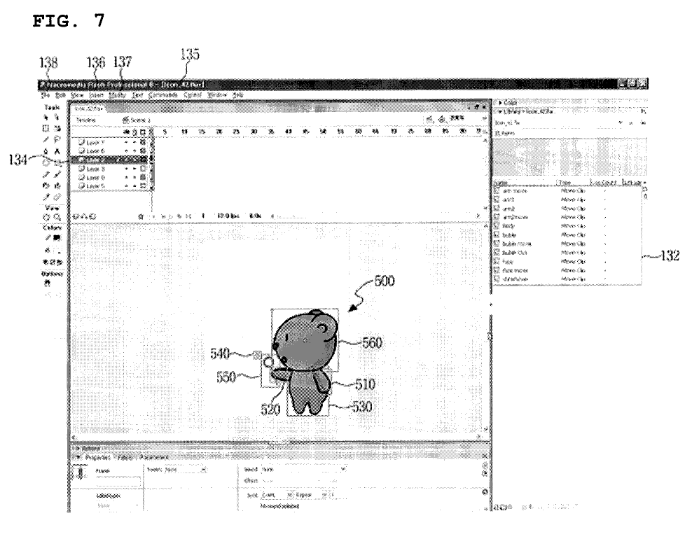

### DESCRIPTION OF REFERENCE CHARACTERS OF PRINCIPAL ELEMENTS

1: mobile terminal
5: controller
10: memory unit
20: key input unit
21: control key
23: numeric/character key
30: OSD
40: encoder
50: selector
60: display unit
70: RF unit
80: interface unit
90: photographing unit

### BEST MODE

It should be understood that the exemplary embodiments of the present invention described below may be modified in many different ways without departing from the inventive principles disclosed herein, and the scope of the present invention is therefore not limited to these particular following embodiments. Rather, these embodiments are provided so that this disclosure will be through and complete, and will fully convey the concept of the invention to those skilled in the art by way of example and not of limitation.

Hereinafter, the present invention will be described in detail with reference to the accompanying drawings. The conventional terms are used to refer elements that function same or substantially same with those of prior art through out the description of the invention.

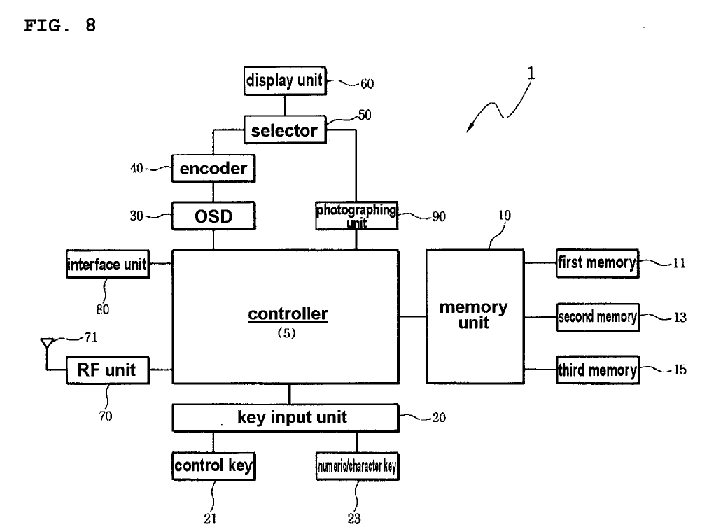

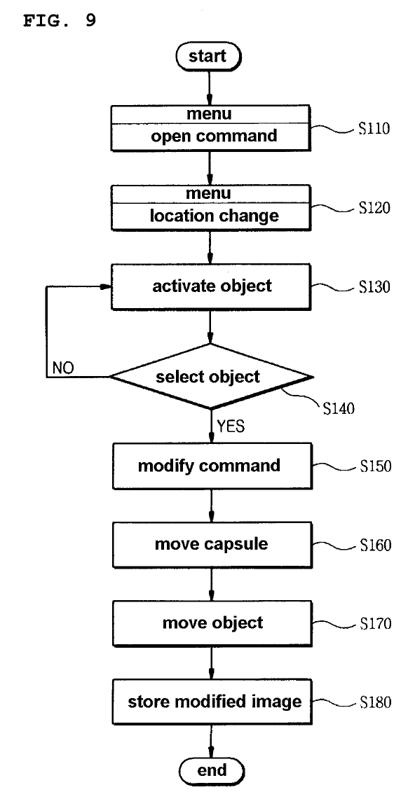

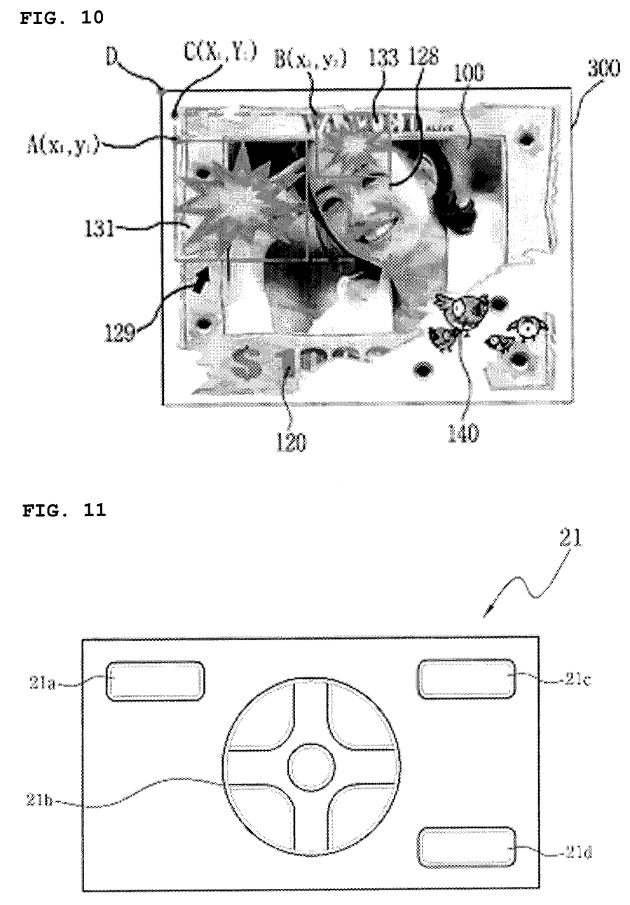

FIG. 8 is a block diagram illustrating a mobile terminal 1 capable of modifying a flash image according to an embodiment of the present invention, FIG. 9 is a flowchart illustrating a method of modifying a flash image according to an embodiment of the present invention, and FIG. 10 illustrates a flash image including an object 130 that is activated and selected.

As shown in FIG. 8, the mobile terminal 1 capable of modifying a flash image according to the embodiment of the present invention includes a memory unit 10, a key input unit 20, a display unit 60 and a controller 5. The memory unit 10 includes a first memory 11 for storing an image, a second memory 13 for storing an operation program, and a third memory 15 for temporarily storing data. The key input unit 20 includes a control key 21 that receives a control command and a numeric/character key 23 that receives an input of a numeric or a character. The display unit 60 displays a numeric or a character or an image under the control of the controller 5. The controller 5 controls the memory unit 10, the key input unit 20 and the display unit 60.

In the embodiment, the memory unit 10 may be implemented with one memory chip for dividing, or may be implemented with separate memory chips. The mobile terminal may have a camera function. In case the mobile terminal has the camera function, a subject may be photographed by a photographing unit 90 shown in FIG. 8, thereby, the photographed image can be displayed on the display unit 60 through a selector 50, or can be stored in the first memory 11. Detailed description of the process of photographing a subject through the photographing unit 90 or storing the photographed image in the first memory 11 will be omitted. The image stored in a particular server or a PC can be downloaded to the first memory 11 that is storing the image, through a radio frequency (RF) unit 70 or an interface unit 80. A reference number 71 that is not described represents a transceive antenna that is connected to the RF unit 70.

With reference to FIGS. 9 to 11, an operation of a flash image editing program included in the memory unit 110 of the mobile terminal in FIG. 8 is described as follows.

First, a flash image stored in the first memory 11, which is to be edited, is displayed on the display unit 60 through a submenu (for example, ‘open’, not shown) which is displayed on the display unit 60 by a menu key 21a that forms the control key 21(S110). Specifically, the flash image may be displayed on the display unit 60 via an On Screen Display (OSD) 30, an encoder 40, and the selector 50 under the control of the controller 5.

In case the flash image for editing is displayed on the display unit 60, one of the objects 120, 130 provided for the flash image through the submenu (for example, ‘location change’, not shown) displayed again by the menu key 21a is activated(S130).

The method of activation can be various. For example, as shown in FIG. 10, the boundary of elements forming the object can be marked. As described above, in case one of the objects 120, 130 is activated, another object for editing may also be activated by using an arrow key 21b.

The object for editing 120 or 130 may be activated by using the arrow key 21b, while the object for editing 120 or 130 is selected by using a confirm key 21d forming the control key 21(S140). In case the selection of the object is wrong, the selection may be cancelled by using a cancel key 21c forming the control key 21, thereby, it can be returned to an activated state.

As shown in FIG. 10, in case the object for editing 120 or 130 is selected by the confirm key 21d, a virtual capsule 128 is generated to encompass the elements 131, 133 forming the object 130. The capsule 128 is virtually created and can be displayed in a solid line or a dotted line on the display unit 60.

The flash image has an information of an object that constitutes the flash image, and an information of the size, the relative position, and the color of each element forming the object.

When the capsule 128 is generated by the selection of the confirm key 21d, a relative position of the capsule 128 to the flash image 300 is extracted from the object provided for the flash image 300 or from the information of the elements forming the object to be stored in the third memory 15 which is a temporary storing unit. The relative position of the elements 131, 133 forming the object 130 for the capsule 128 is also extracted to be stored in the third memory 15.

FIG. 10 illustrates an example of extracting a relative position. Referring to FIG. 10, in case the activated object for editing 130 is selected by the confirm key 21d (S140), a capsule 128 including the elements 131, 133 forming the object 130 is generated. Here, the capsule 128 is a minimum rectangular shape. With the generation of the capsule 128, the relative coordinate X₁, Y₁ of a reference point C of the capsule 128 for a reference point D of the flash image 300 is obtained to be stored into the third memory 15. Also, as to the elements 131, 133 forming the object 300, the relative coordinates (x₁, y₁), (x₂, y₂) of the reference point C are obtained respectively to be stored into the third memory 15.

In the above, the X₁, Y₁ denote the horizontal and the vertical distance from the reference point of the flash image 300 to the reference point C of the capsule 128. The x₁, y₁ denote the horizontal and the vertical distance from the reference point of the capsule 128 to the reference point A of the element 131. The x₂, y₂ denote the horizontal and the vertical distance from the reference point of the capsule 128 to the reference point B of the element 133, while the unit is a pixel.

It will be understood that the reference points A, B, C and D in the above are arbitrary given for illustration, thus, other points can be available. In addition, it is preferable that a movement indicator 129 is displayed on the flash image 300 so as to easily detect the distance of movement of the object for editing 131.

When the arrow key 21b of the control key is pressed while the object 131 for moving is selected as described, the relative coordinate of the capsule 128 which is temporarily stored in the third memory 15 is changed due to the press of the arrow key 21b. Further, the relative coordinate of the elements 131, 133 shown in the third memory 15 is changed due to the coordinate movement.

The object 130 moves a predetermined distance, while the modified relative coordinate is replaced with the coordinate of the elements 131, 133 of the object 130 which is initially included in the information of the flash image 300, thus, it can be stored as a flash image having the object 130 which has moved to a new position.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

According to the present invention, a flash image stored in a SWF format is not required to be converted into a FLA format. The present invention makes it possible to directly modify the position of an object forming the flash image of SWF format. Accordingly, the flash image can be easily modified without the FLA de-compiler for a flash image.

1. A mobile terminal capable of editing a flash image, the mobile terminal comprising:
a memory unit including:
a first memory that stores an image;
a second memory that stores an editing program; and
a third memory that is a temporal memory temporarily storing a data;
a key input unit including:
a control key that receives a control command; and
a numeric/character key that receives a numeric or a character; and
a display unit that displays a numeric, a character or an image inputted under the control of a controller,
wherein an editing program stored in the second memory is configured to execute the steps of,
activating an object provided for a flash image displayed on the display unit;
selecting the activated object by the control key and capsulating the selected object;
modifying the capsulated object; and
storing the modified flash image into the first memory.

2. The mobile terminal of claim 1, wherein the capsulating of the selected object includes:
generating a capsule that encompasses elements forming the selected object;
generating a relative coordinate for a reference point of the generated capsule to be stored into the third memory; and
obtaining a relative position(coordinate) of the elements of the object for the generated capsule to be stored into the third memory.

3. The mobile terminal of claim 1, wherein the modifying of the capsulated object includes:
modifying the relative coordinate of the capsule by pressing an arrow key;
modifying the relative coordinate of the elements for the capsule to be stored into the third memory; and
moving the selected object to a new position by replacing the relative coordinate of the capsule and the relative coordinate of the elements which are modified to be stored with the relative coordinate of the elements provided for the flash image.

4. A method of modifying a flash image in accordance with the mobile terminal of claim 1 capable of modifying the flash image, the method comprising:
displaying the flash image stored in a first memory of the mobile terminal on a display unit;
activating an object forming the displayed flash image in response to the selection of a location change menu;
selecting the activated object;
capsulating the selected object;
modifying the capsulated object; and
storing the modified flash image.

5. The method of claim 4, wherein the capsulating of the selected object includes:
generating a capsule that encompasses elements forming the object in case of selecting the object;
generating a relative coordinate for a reference point of the generated capsule;
obtaining a relative coordinate of the elements of the selected object for the reference point of the capsule; and
storing the relative coordinate of the capsule and the relative coordinate of the element forming the object for the capsule into the third memory.

6. The method of claim 4, wherein the modifying the capsulated object includes:
modifying the relative coordinate of the capsule and the relative coordinate of the elements for the capsule by pressing the arrow key to be stored into the third memory; and
moving the selected object to a new position by replacing the relative coordinate of the capsule and the relative coordinate of the elements which are modified to be stored with the relative coordinate of the elements provided for the flash image.

7. The mobile terminal of claim 2, wherein the modifying of the capsulated object includes:
modifying the relative coordinate of the capsule by pressing an arrow key;
modifying the relative coordinate of the elements for the capsule to be stored into the third memory; and
moving the selected object to a new position by replacing the relative coordinate of the capsule and the relative coordinate of the elements which are modified to be stored with the relative coordinate of the elements provided for the flash image.

8. The method of claim 5, wherein the modifying the capsulated object includes:
modifying the relative coordinate of the capsule and the relative coordinate of the elements for the capsule by pressing the arrow key to be stored into the third memory; and
moving the selected object to a new position by replacing the relative coordinate of the capsule and the relative coordinate of the elements which are modified to be stored with the relative coordinate of the elements provided for the flash image.
